(19) United States
(12) Patent Application Publication
(10) Pub. No.: US 2006/0203776 A1
(43) Pub. Date: Sep. 14, 2006

(54) Handoff solution for converging cellular networks based on multi-protocol label switching

(75) Inventors: Rajendra Persaud, Dusseldorf (DE); Gerald Berghoff, Dusseldorf (DE); Ralf Schanko, Dusseldorf (DE)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/362,705

(22) Filed: Feb. 28, 2006

Related U.S. Application Data
(60) Provisional application No. 60/656,931, filed on Feb. 28, 2005.

(51) Int. Cl. H04Q 7/00

(52) U.S. Cl. 370/331

(57) ABSTRACT

A network device for enabling handoff of a mobile device from a first point of attachment to a second point of attachment. The network device includes a component for implementing a protocol wherein incoming packets are forwarded based on predefined label switched paths. When a mobile station moves from a first point of attachment to a second point of attachment, the mobile station issues a handoff request message to an attached serving support node which relays the message to an associated gateway support node. Each intermediate node receiving the request message takes action so that incoming packets destined for the mobile station are rerouted on a predefined handoff label switched path. During handoff from the first point of attachment to the second point of attachment incoming packets are forwarded from the serving support node to the second point of attachment

This application claims priority of U.S. Provisional Patent Application Ser. No. 60/656,931, filed on Feb. 28, 2005. The subject matter of this earlier filed application is hereby incorporated by reference.

### BACKGROUND OF THE INVENTION

1. Field of the Invention

This invention is related to packet switched handoffs in cellular networks, and in particular to the utilization of Multi-Protocol Label Switching in a core network of cellular networks, and a handoff solution therefore.

2. Description of the Related Art

A Universal Mobile Telecommunications Service (UMTS) system is a third-generation system that is based on the Global System for Mobile (GSM) communication standard and is created to provide global mobility with a wide range of services including telephony, paging, messaging, Internet and broadband data. A UMTS network is composed of one or more Radio Access Networks (RANs) and a core network. The radio access network includes the mobile station, the base station, and the radio interface between them. The RANs may be one or more of a UMTS Terrestrial RAN (UTRAN), the GSM/General Packet Radio Service (GPRS) RAN and the GSM/Enhanced Data rate for GSM Evolution (EDGE) RAN (GERAN). The core network provides switching, routing and transit functions for user traffic and is subdivided into a packet switched domain and a circuit switched domain.

As is apparent to those skilled in the art, different access technologies have different notions. For example, a mobile station may be connected to a base station in a GSM network, to a Node-B in a UMTS network, and an access point in a WLAN. In order to cover different access technologies, a generic term “point of attachment” is used in the present application.

In a UMTS network, when the mobile station moves between points of attachment a soft handoff is possible, wherein when the mobile station moves from one UMTS base station/Node-B to another, a soft handoff may be performed when the lur interface of the radio network ontroller is present. During soft handoff, the packets directed to the mobile station are sent simultaneously via the old and the new points of attachment/Node-B yielding a seamless handoff without any noticeable interruption.

In a GSN/GPRS/EDGE network, on the other hand, when a mobile moves from one point of attachment/base station to another, a hard handoff is performed. As soon as the connection to the mobile station via a new point of attachment/base station is available, all packets directed to the mobile station are abruptly sent via the new point of attachment. The hard packet-switched handoff is performed by updating the packet data protocol context at the concerned Serving GPRS Support Nodes (SGSN) and the concerned Gateway GPRS Support Node (GGSN). During the update process, however, all packets transferred to the old point of attachment are lost when the mobile station leaves the range of the old point of attachment, in other words, the handoff is not seamless. The above described situation is also true when only one of the points of attachment belong to a GSM/GPRS RAN or GERAN.

For handoffs between second generation and third generation points of attachment and points of attachment of other access technologies, such as Wireless LAN (WLAN), no solutions have yet been standardized. As networks of different technology such as WLANs and Wireless Metropolitan Area Networks (WirelessMANs) are already entering cellular networks, current handoff solutions will have to be extended to account for these technologies.

One solution that is about to be standardized is Unlicensed Mobile Access (UMA) and the proposal is to use GPRS Mobility Management (GMM) transparently over the IEEE access technology. Since GMM does not allow for seamless handoffs, this solution cannot be used for real-time packet switched services. Furthermore, GMM is based on the use of the GPRS Tunnelling Protocol (GTP) wherein messages are transported over the User Datagram Protocol (UDP) and the Internet Protocol (IP), thereby causing the resulting protocol stack to become very complex.

Layer-3 solutions such as Mobile IP, Mobile IPv4 Regional Registration, Low Latency Handoffs in Mobile IPv4, Fast Handoffs for Mobile IPv6 all introduce considerable additional overhead through IP tunnelling and a large amount of control messages. Even with fast handoffs that may be provided with Layer 3 solution, where the acquisition of a new IP address is moved before the layer-2 handoff, the validity check of the new IP address, which can only be performed after the layer-2 handoff, increases the outage time considerably. Furthermore, the establishment of a Bidirectional Edge Tunnel and the signalling between old and new points of attachment is detrimental in environments where handoffs occur very frequently and where the time for handoff is very short. Other layer-3 solutions such as HAWAII and Cellular IP are not scalable since host-specific routes are used.

### SUMMARY OF THE INVENTION

According to one aspect of the invention, there is provided a network device for enabling handoff of a mobile device from a first point of attachment to a second point of attachment. The network device includes a component for implementing a protocol wherein incoming packets are forwarded based on predefined label switched paths. When a mobile station moves from a first point of attachment to a second point of attachment, the mobile station issues a handoff request message to an attached serving support node which relays the message to an associated gateway support node. Each intermediate node receiving the request message takes action so that incoming packets destined for the mobile station are rerouted on a predefined handoff label switched path. During handoff from the first point of attachment to the second point of attachment incoming packets are forwarded from the serving support node to the second point of attachment

According to another aspect of the invention, there is provided a method for enabling handoff of a mobile device from a first point of attachment to a second point of attachment. The method includes the steps of implementing a protocol wherein incoming packets are forwarded based on predefined label switched paths and issuing, by a mobile station, a handoff request message to an attached serving support node which relays the message to an associated gateway support node when the mobile station moves from a first point of attachment to a second point of attachment. The method also includes the steps of acting, by each intermediate node receiving the request message, so that incoming packets destined for the mobile station are rerouted on a predefined handoff label switched path and forwarding the incoming packets from the serving support node to the second point of attachment during handoff from the first point of attachment to the second point of attachment.

According to another aspect of the invention, there is provided an apparatus for enabling handoff of a mobile device from a first point of attachment to a second point of attachment. The apparatus includes implementing means for implementing a protocol wherein incoming packets are forwarded based on predefined label switched paths. The apparatus also includes issuing means for issuing, by a mobile station, a handoff request message to an attached serving support node which relays the message to an associated gateway support node when the mobile station moves from a first point of attachment to a second point of attachment. The apparatus further includes acting means for acting, by each intermediate node receiving the request message, so that incoming packets destined for the mobile station are rerouted on a predefined handoff label switched path and forwarding means for forwarding the incoming packets from the serving support node to the second point of attachment during handoff from the first point of attachment to the second point of attachment.

According to another embodiment of the invention, there is provided an ingress router for enabling handoff of a mobile device from a first point of attachment to a second point of attachment. The ingress router includes a unit for receiving incoming packets from a mobile device using a protocol, wherein incoming packets are forwarded based on predefined label switched paths when the mobile device roams from a first point of attachment to a second point of attachment. The ingress router also includes a unit for optionally routing the incoming packet through a switching router and a unit for transmitting the incoming packet at an egress router for further distribution to a component that is attached to the egress router. The mobile device issues a handoff request message to an attached serving support node which relays the message to an associated gateway support node when the mobile station moves from the first point of attachment to the second point of attachment. Each intermediate node receiving the request message takes action so that incoming packets destined for the mobile station are rerouted on a predefined handoff label switched path and wherein during handoff from the first point of attachment to the second point of attachment incoming packets are forwarded from the serving support node to the second point of attachment.

Another embodiment of the invention provides a serving support node for enabling handoff of a mobile device from a first point of attachment to a second point of attachment. The serving support node includes a unit for receiving handoff request message when a mobile station moves from a first point of attachment to a second point of attachment and a unit for relaying the request message to an associated gateway support node. Each intermediate node receiving the request message takes action so that incoming packets destined for the mobile station are rerouted on a predefined handoff label switched path and wherein during handoff from the first point of attachment to the second point of attachment incoming packets are forwarded from the serving support node to the second point of attachment. Handoff is implemented in a system implementing a protocol wherein incoming packets are forwarded based on predefined label switched paths.

Another embodiment of the invention provides a mobile device using a protocol wherein incoming packets are forwarded based on predefined label switched paths when the mobile device roams from a first point of attachment to a second point of attachment. The mobile device includes a unit for issuing a handoff request message to an attached serving support node which relays the message to an associated gateway support node when the mobile station moves from a first point of attachment to a second point of attachment. Each intermediate node receiving the request message takes action so that incoming packets destined for the mobile station are rerouted on a predefined handoff label switched path and wherein during handoff from the first point of attachment to the second point of attachment incoming packets are forwarded from the serving support node to the second point of attachment.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates a network in which embodiments of the invention may be practiced;

FIG. 2 illustrates an embodiment of the inventive MPLS based handoff implementation;

FIGS. 3a-3f illustrates various tables that are used in the embodiment illustrated by FIG. 2; and

FIG. 4 the steps implemented in an embodiment of the present invention.

### DETAILED DESCRIPTION OF PREFERRED EMBODIMENTS OF THE INVENTION

Reference will now be made to the preferred embodiments of the present invention, examples of which are illustrated in the accompanying drawings.

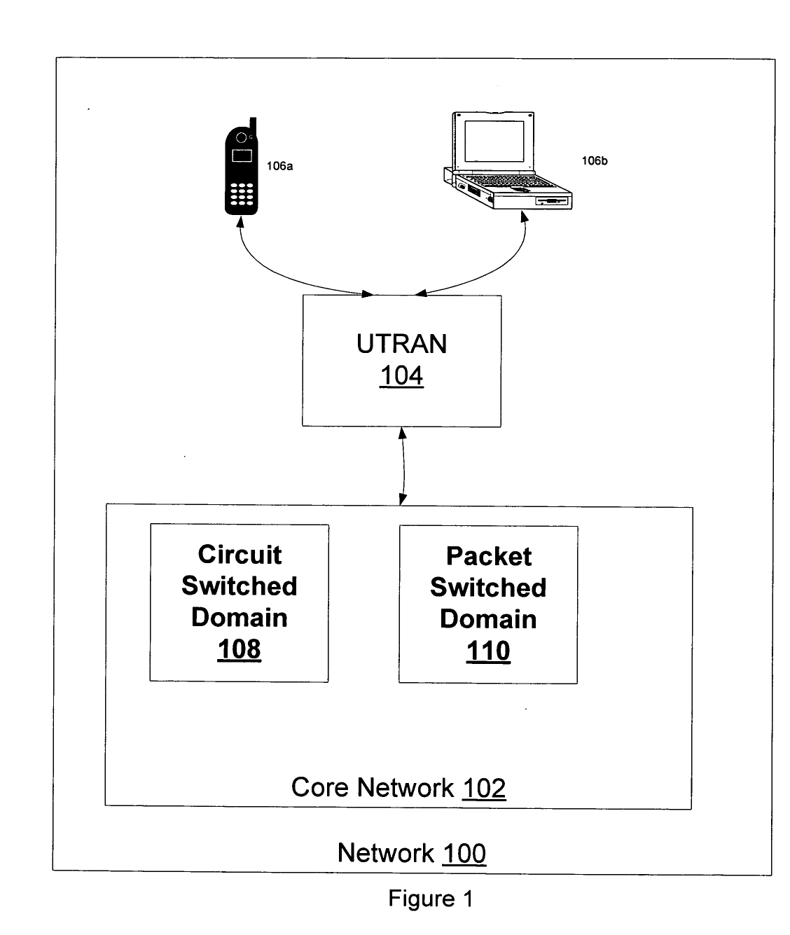

FIG. 1 illustrates a network in which embodiments of the invention may be practiced. The network is a UMTS network 100 that includes a core network 102, UMTS Terrestrial Radio Access Network (UTRAN) 104 and user equipment 106. Core network 102 provides switching, routing and transit for user traffic. UTRAN 104 provides the air interface access method for the user equipment 106. The Core Network is divided in a circuit switched domain 108 and a packet switched domain 110. Some of the circuit switched elements are a Mobile services Switching Centre (MSC), a Visitor location register (VLR) and Gateway MSC and some of the packet switched elements are Serving GPRS Support Node (SGSN) and Gateway GPRS Support Node (GGSN). Some network elements, like EIR, HLR, VLR and AUC are shared by both domains.

One embodiment of the invention uses a Multi-Protocol Label Switching (MPLS) protocol that allows for fast and efficient packet forwarding and that is based on the establishment of label switched paths. According to this embodiment, the MPLS is to be used in core network 102 of cellular networks, wherein packet switched handoffs for and between all types of radio access networks connected to core network 102 can be seamlessly supported. The inventive system, therefore, reduces handoff time and packet loss considerably for packet switched applications.

According to an embodiment of the invention, label switched paths are set up a priori from all GGSNs to all SGSNs for all their interfaces so that any interface change can be reflected by the appropriate change of label switched path. A handoff request message is issued by the mobile station to the SGSN to which the mobile station is attached. After SGSN receives the handoff request message, it relays the handoff request message to all GGSNs. Each intermediate label switched path, between the SGSN and the GGSNs, receiving the handoff request message then takes immediate action so that each incoming packet destined to the mobile station is rerouted on a handoff label switched path that is set up a priori as well. As the handoff label switched paths are directed to a new point of attachment of the mobile station, the packets are continuously rerouted in an optimal way until the handoff request message reaches the GGSNs where they are finally placed on a different label switched path directed to the new point of attachment.

According to one embodiment of the invention, the IP/UDP/GTP protocol suite can be replaced by MPLS on the user plane. On the control plane, the Resource Reservation Protocol for Traffic Engineering (RSVP-TE) can take over the task of setting up the label switched paths and of treating the handoff request message correctly.

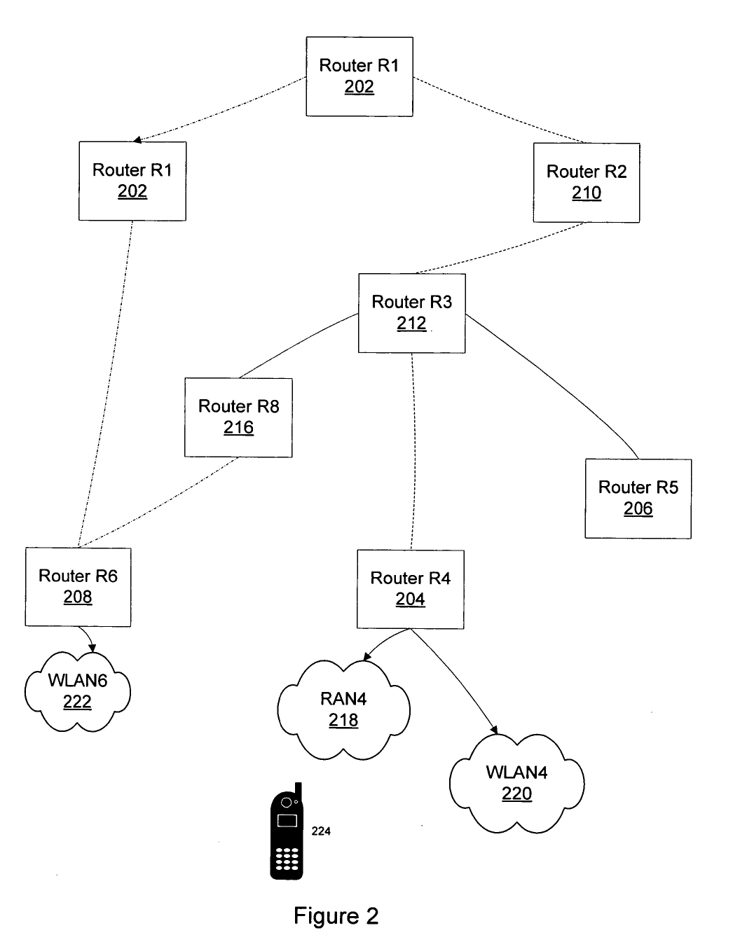

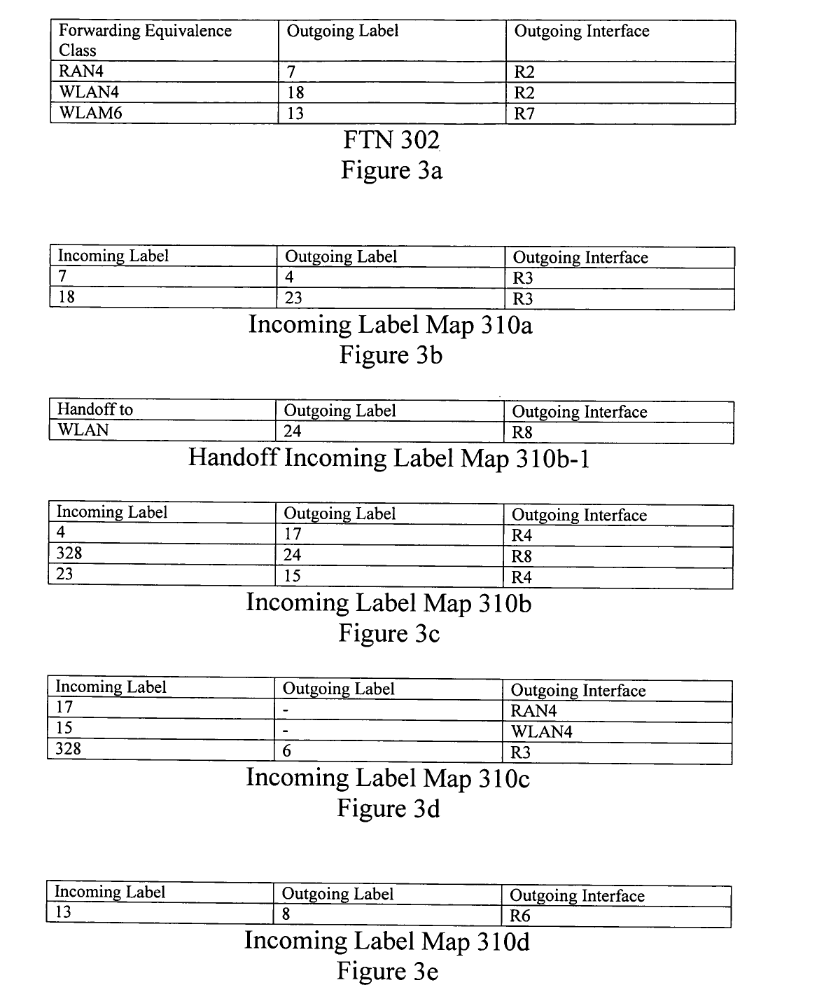

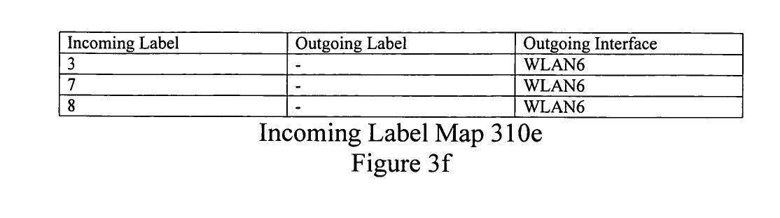

FIG. 2 illustrates an embodiment of the inventive MPLS based handoff implementation. According to FIG. 2, IP packets may arrive at R1 202 which is an ingress label edge router. R4 204, R5 206 and R6 208 are three possible downstream egress label edge routers and R2 110, R3 212, R7 214 and R8 216 are simple label switching routers. As shown in FIG. 2 by the dashed lines, R1 202 has established two label switched paths to R4 204 for networks RAN4 218 and WLAN4 120 that are attached to two interfaces of R4 204. A corresponding Forwarding Equivalence Class-To-Next Hop Label Forwarding Entry map (FTN) 302, as shown in FIG. 3a, includes two entries 304 and 306 for these networks. Label switching routers R2 110 and R3 212 as well as the downstream egress label edge router R4 204 have corresponding entries in their respective incoming label maps 310a-310c, as shown by FIGS. 3b-3d. R1 202 has a further label switched path, represented by the dashed-dotted lines, to the downstream egress label edge router R6 206 for network WLAN6 122. As such, the entries in FTN 302 and in incoming label maps 310d and 310e of R7 214 and R6 216 respectively are set accordingly, as shown by FIGS. 3e and 3f.

In this embodiment, for example, a user 224 with a user ID of 328 and an IP address of 137.226.12.196 is located at a point of attachment in RAN4 218. Each IP packet arriving at ingress label edge router R1 202 and destined to user 224 is classified by R1 202 by looking for the associated IP destination address in its classification table. The classification result is the user ID, in this case, 328 and a forwarding equivalence class of RAN4 218. The forwarding equivalence class is then used as search index in FTN 302 in order to retrieve an outgoing label, in this case 7, and an outgoing interface to R2 110. The packet may then be equipped with that outgoing label and the user ID of 328 and is then sent to the outgoing interface to R2 110. In one embodiment, the packet may be equipped with the outgoing label and the user ID in an additional MPLS header. In another embodiment, the packet may be equipped with the outgoing label and the user ID in a proper header.

Upon receiving the packet, label switching router R2 110 first looks into its handoff incoming label map by using the user ID as an index. FIG. 3c illustrates a handoff incoming label map 310b-i that is associated with router R3 112. If router R2 110 does not retrieve an entry with results, R2 110 looks into incoming label map 310a by using the incoming label, in this case 7, as an index to retrieve the outgoing label, which is 4, and the outgoing interface to R3 212. R2 110 then switches the incoming label to the outgoing label and forwards the packet to the outgoing interface to R3 212.

R3 212 processes the packet in an analogous manner so that the packet can arrive at R4 204. When R4 204 searches its incoming label map 310c and retrieves an empty entry from its handoff incoming label map, it finds an explicit null label in incoming label map 310c which indicates that both the label and the user ID have to be popped from the MPLS packet. As the outgoing interface is a virtual interface of a handler for RAN4 218, the packet may be treated appropriately and is finally delivered to RAN4 218.

If user 224 moves from the current point of attachment in RAN4 218 to a target point of attachment in WLAN6 212, as soon as user 224 decides to handoff, a handoff request message is emitted. The handoff request message is an IP diagram with an IP source address, which in this case is 137.226.12.196, and a broadcast IP destination address. A broadcast IP destination address is used since user 224 may receive traffic from several ingress label edge routers before and during handoff. As such, it would not be reasonable to have user 224 send multiple handoff request messages to these ingress label edge routers. The handoff request message includes the user ID, in this case 328, the network ID of the current point of attachment, in this case RAN4 218 and the network ID of the new/target point of attachment, in this case WLAN6 122. Upon receipt of the handoff request message, R4 204 first looks into its handoff table using the network ID of the target point of attachment as an index to retrieve the handoff outgoing label, in this case 6, and the handoff outgoing interface of R3 212. If the handoff incoming label map does not already include an entry at the index of the user ID, the handoff outgoing label and the handoff outgoing interface values are transferred into the handoff incoming label map at the index for the user ID and a pending handoff response message counter is initialized. According to one embodiment of the invention, the handoff response message counter is initialized to zero. Thereafter, any arriving packet for user 224 with the associated UID will be forwarded on the handoff label switched path from R4 204 over R3 212 and R8 216 to R6 206.

R4 204 then sends the handoff request message to all ingress label edge routers, in this example to R1 202. For each ingress label edge router and each label switched path from that ingress label edge router to R4 204, R4 204 looks into its upstream map using as index the network ID of RAN4 218 and the router ID of the ingress label edge router. R4 204 then retrieves the outgoing interface or interfaces, which is possible in the case of several label switched paths, forwards the handoff request message out on that interface/interfaces and increases the pending handoff response message counter in the handoff incoming label map by one. Upon receipt of the handoff request message, each ingress label edge router changes an entry in its classification map. So continuing with our example, R1 202 changes its classification map by substituting forwarding equivalence class RAN4 218 with WLAN6 122 for the IP destination address associated with user 224. After that, further packets arriving at R1 202 are directly placed on the label switched path from R1 202 over R7 214 to R6 208. Upon sending the handoff request message to all ingress label edge router, R4 204 responds with a handoff response message to the mobile station in order to acknowledge receipt of the handoff request message.

All further label switched routers processing the handoff request message proceed in a similar way. After, for example, R3 212 has processed the handoff request message, further packets arriving at R3 212 for user 224 are redirected onto the label switched path from R3 212 over R8 216 to R6 208. When R4 204 receives the handoff response message from R3 212, R4 204 decreases the pending handoff response message counter and only when that counter is equal to zero, may R4 204 delete the entry in the handoff incoming label map.

In an embodiment of the invention, to prevent potential attackers from issuing a handoff request message on behalf of the mobile station, the handoff request message has to be authenticated. The authentication context should be shared by the mobile station and the SGSNs (as in GPRS or UMTS). In order not to unnecessarily delay the handoff process, authentication is performed on power-up and periodically between handoffs. Therefore, the SGSN the mobile station handoffs to has to be in possession of the same authentication context as the old SGSN that the mobile station is still attached to.

According to an embodiment of the invention, on power-up, the mobile station authenticates with a certain SGSN. That SGSN forwards the authentication context to all neighbouring SGSNs that the mobile station might handoff to. As soon as the mobile station handoffs to one of these neighbour/new SGSNs, that new SGSN again forwards the authentication context to all its neighbouring SGSNs. Furthermore, the new SGSN notifies the old SGSN of the completed handoff after which the old SGSN notifies its neighbour SGSNs to release the authentication context of the mobile station. In order to decide which notification message is the newest, the notification messages may be equipped with a sequence number. Note that if an SGSN is attached to several radio access networks, a handoff between these radio access networks should not trigger the exchange of any authentication context.

In an embodiment of the invention, the handoff request message can be authenticated in a similar way as the network-to-user authentication in UMTS. The network generates an authentication token including a sequence number, an authentication management field and a message authentication code which is itself calculated as a function of the sequence number, the authentication management field, a random number and a secret Kᵢ shared between the Authentication Center and the mobile station. The random number and the authentication token are transmitted to the mobile station that can then authenticate the network by recalculating the message authentication code. If the recalculated value equals the transmitted message authentication code, the network is considered authenticated.

In another embodiment of the invention, the message exchange is performed the other way round so that the mobile station chooses the random number, generates the authentication token and sends the random number and the authentication token within the handoff request message to the concerned SGSN that can then authenticate the mobile station. In that case, no further messages have to be exchanged on the air interface apart from the handoff request message. The inventive system thereby reduces handoff delay and packet loss when performing handoff between points of attachment of different access technologies. Examples of the MPLS solution discussed above are thus more efficient and powerful when compared to other IP based solutions.

Furthermore, as is known to those of ordinary skill in the art, mobile IP is based on IP tunnelling. When a correspondent node has an IP packet to send to a mobile station, it has to send the IP packet to the fixed home address of the mobile station where it is intercepted by the home agent which tunnels the packet to the current location of the mobile station. At the current location, the packet is detunnelled and finally delivered. IP tunnelling introduces additional processing delay at the tunnel endpoints and it also significantly increases the overhead through the additional IP header. The present invention, on the other hand, reduces additional overhead to a minimum.

Additionally, many handoff solutions, such as Mobile IP, Hierarchical and Mobile IP, etc require that a handoff notification message be sent to a possibly very distant node, such as home agent or a gateway foreign agent before packets can be rerouted in direction of the new point of attachment. This requirement causes many packets to become lost during the handoff process. With the present invention, packets are rerouted as soon as possible, i.e. as soon as the handoff notification message reaches a certain hop, that hop starts rerouting the packets in the direction of the new point of attachment so that a seamless handoff is possible. This results in less handoff delay and thus less packet loss.

As multi-protocol label switching is based on the establishment of label switching paths, packets can easily be duplicated on another label switching path by adding a corresponding entry into incoming label map 310 of the responsible label switching router. In an embodiment of the invention, an incoming MPLS packet would then be labelled as switched twice, once on the original label switching path and once on the handoff label switching path for which the entry has been newly added to incoming label map 310. One result of this embodiment is that duplicated IP packets are sent to the mobile station.

In the present invention, a change of IP addresses can be also avoided by adapting a standard behaviour of an egress label edge router. Normally, after taking off the label from an MPLS packet, the egress label edge router forwards the resulting IP packet according to normal IP operation. Specifically, the egress label edge router first checks if the IP address belongs to a subnet to which it is connected. If it is, the egress label edge router checks its address resolution protocol table in order to find the Medium Access Control (MAC) address to equip the IP packet with. Otherwise, it checks its routing table in order to forward the packet to the appropriate next hop. In one embodiment of the invention, after taking off the label, the egress label edge router would have to forward the resulting IP packet on the outgoing interface in the direction of the point of attachment. The outgoing interface could be stored, for example in incoming label map 310. In order to be able to equip the IP packet with the correct MAC address, the mobile station would still have to send a gratuitous address resolution protocol with which the address resolution protocol table of the egress label edge router would be updated. So when the egress label edge router receives an MPLS packet it would pop off the MPLS header, look up the IP address in its address resolution protocol table, add the corresponding MAC header and forward the resulting frame to the outgoing interface stored in its incoming label map. One advantage of not needing a new IP address is less signalling since no Dynamic Host Configuration Protocol (DHCP) messages would have to be exchanged and consequently less handoff delay.

While some handoff solutions propose to use host-specific routes to reflect the current point of attachment of a MS, in cellular networks with several thousands of users, that approach cannot be considered as scalable. The current invention, however, offers the possibility of grouping the traffic to all users reachable via one of the interfaces of an SGSN to a forwarding equivalence class. If a user changes the point of attachment and if that change results in the change of the interface at the corresponding SGSN or the SGSN itself, its traffic is assigned the corresponding other FEC so that no per-user routing is necessary which makes the MPLS approach a scalable one.

A person of ordinary skill in the art would understand that, in the implementation of this invention, certain security features may be considered and implemented based on the necessary application. With appropriate security/authentication, the upstream travelling of the handoff notification message enables concerned label switching routers to update their tables, wherein packets for the concerned node are continuously rerouted based upon the best available shortcut until the forwarding equivalence class at the GGSN is updated.

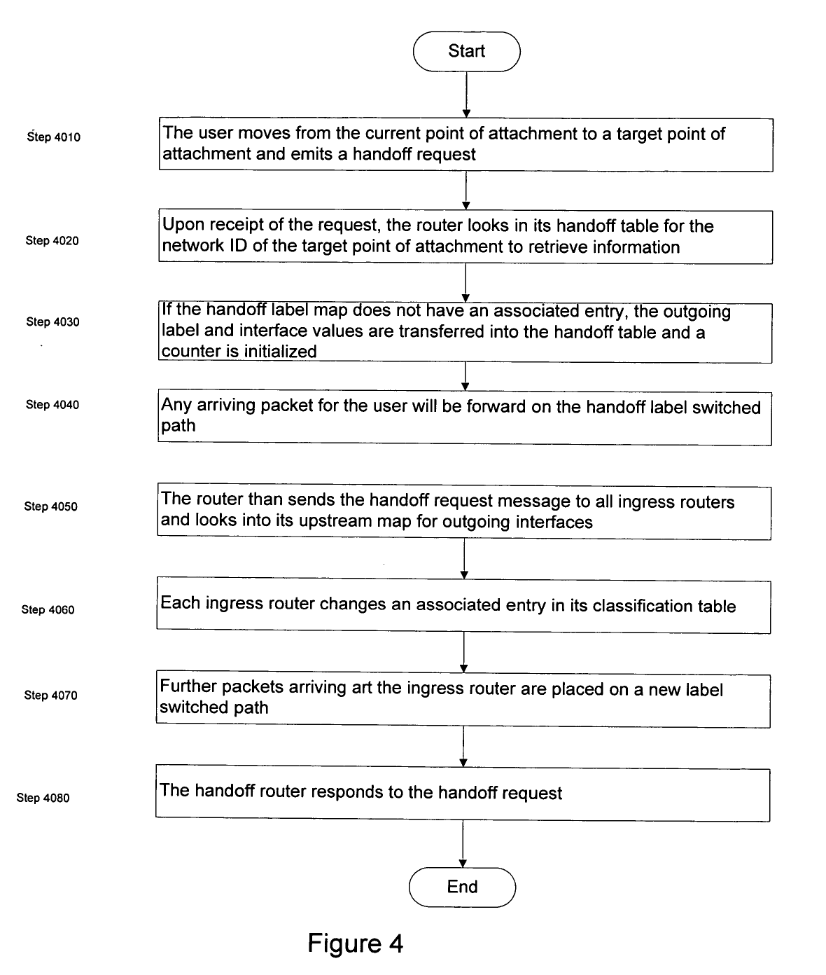

FIG. 4 illustrates the steps implemented in the inventive system. In Step 4010, user 224 moves from the current point of attachment in RAN4 218 to a target point of attachment in WLAN6 212 and a handoff request message is emitted. In Step 4020, upon receipt of the handoff request message, R4 204 first looks into its handoff table using the network ID of the target point of attachment as an index to retrieve the handoff outgoing label, and the handoff outgoing interface of R3 212. In Step 4030, if the handoff incoming label map does not already include an entry at the index of the user ID, the handoff outgoing label and the handoff outgoing interface values are transferred into the handoff incoming label map at the index for the user ID and a pending handoff response message counter is initialized. In Step 4040, any arriving packet for user 224 with the associated UID will be forwarded on the handoff label switched path from R4 204 over R3 212 and R8 216 to R6 206.

In Step 4050, R4 204 then sends the handoff request message to all ingress label edge routers and looks into its upstream map using as index the network ID of RAN4 218 and the router ID of the ingress label edge router for outgoing interface(s). In Step 4060, upon receipt of the handoff request message, each ingress label edge router changes an entry in 316 classification map. In Step 4070, further packets arriving at R1 202 are directly placed on the label switched path from R1 202 over R7 214 to R6 208. In Step 4080, upon sending the handoff request message to all ingress label edge router, R4 204 responds with a handoff response message to the mobile station in order to acknowledge receipt of the handoff request message.

The foregoing description has been directed to specific embodiments of this invention. It will be apparent; however, that other variations and modifications may be made to the described embodiments, with the attainment of some or all of their advantages. Therefore, it is the object of the appended claims to cover all such variations and modifications as come within the true spirit and scope of the invention.

What is claimed:

1. A network device for enabling handoff of a mobile device from a first point of attachment to a second point of attachment, the network device comprising:
a component for implementing a protocol wherein incoming packets are forwarded based on predefined label switched paths,
wherein when a mobile station moves from a first point of attachment to a second point of attachment, the mobile station issues a handoff request message to an attached serving support node which relays the message to an associated gateway support node, and
wherein each intermediate node receiving the request message takes action so that incoming packets destined for the mobile station are rerouted on a predefined handoff label switched path and wherein during handoff from the first point of attachment to the second point of attachment incoming packets are forwarded from the serving support node to the second point of attachment.

2. The network device according to claim 1, wherein the network device is configured to continuously reroute the incoming packets, while the predefined handoff label switched path is directed to a new point of attachment, until the request message reaches the gateway serving node where it is placed on a different label switched path that is directed to a new point of attachment.

3. The network device according to claim 1, wherein the label switched paths are predefined for interfaces from the gateway support node to the serving support node such that any interface change is reflected by an appropriate label switched path.

4. The network device according to claim 1, wherein the component for implementing the protocol is located in a core network.

5. The network device according to claim 1, wherein the network device is configured to received incoming packets at an ingress router, to optionally route the incoming packet through a switching router, and to receive the incoming packet at an egress router for further distribution to a component that is attached to the egress router.

6. The network device according to claim 5, wherein each of the ingress router, switching router and egress router is configured to use at least one table for determining a routing path for the incoming packet.

7. The network device according to claim 5, wherein the network device is configured to amend the incoming packet with information that is retrieved from the at least one table.

8. The network device according to claim 5, wherein upon receiving the incoming packet, the switching router is configured to examine an associated handoff table and, if predefined information is not retrieved from the handoff table, to examine an associated incoming label map for further routing information.

9. The network device according to claim 5, wherein upon receiving the incoming packet, the egress router is configured to examine an associated incoming label map and upon retrieving a null label, amend the incoming packet prior to forwarding the incoming packet to an appropriate point of attachment.

10. The network device according to claim 1, wherein the request message is an Internet Protocol diagram comprising an Internet Protocol source address and a broadcast Internet Protocol destination address, the request message further comprises a user identifier, a network identifier for the first point of attachment and a network identifier for the second point of attachment.

11. The network device according to claim 1, wherein the upon receipt of the request message, the serving support node is configured to examine an associated table for forwarding information for the second point of attachment and, if predefined information is not retrieved from the associated table, to update the associated table with the forwarding information for the second point of attachment and to initialize a pending message counter.

12. The network device according to claim 1, wherein upon receiving the request message, the serving support node is configured to examine an upstream map for each associated gateway support node and for each label switched path from the associated gateway support node, to retrieve at least one interface and to forward the request message on the retrieved interface, the serving support node is further configured to update a pending counter.

13. The network device according to claim 1, wherein upon receiving the request message, the gateway support node is configured to change an entry in a classification table to reflect the handoff request, wherein upon updating the classification table, incoming packets to the mobile station are routed on a new label switched path.

14. The network device according to claim 1, wherein upon sending the request message to the gateway support node, the serving support node is configured to send a responds message to the mobile station.

15. The network device according to claim 1, wherein the mobile station is configured to authenticate with the serving support node which forwards an authentication context to all neighboring serving support nodes that the mobile station might handoff to.

16. The network device according to claim 1, wherein the network device is configured to authenticate the handoff request message by generating an authentication token comprising a sequence number, an authentication management field and an authentication code, the network device is further configured to transmit the authentication token and a random number to the mobile station for the mobile station to authenticate the network.

17. The network device according to claim 1, wherein the mobile station is configured to authenticate the handoff request message by generating an authentication token comprising a sequence number, an authentication management field and an authentication code, the mobile station is further configured to transmit the authentication token and a random number to the network device for the network device to authenticate the mobile station.

18. A method for enabling handoff of a mobile device from a first point of attachment to a second point of attachment, the method comprises the steps of:
implementing a protocol wherein incoming packets are forwarded based on predefined label switched paths,
issuing, by a mobile station, a handoff request message to an attached serving support node which relays the message to an associated gateway support node when the mobile station moves from a first point of attachment to a second point of attachment;
acting, by each intermediate node receiving the request message, so that incoming packets destined for the mobile station are rerouted on a predefined handoff label switched path; and
forwarding the incoming packets from the serving support node to the second point of attachment during handoff from the first point of attachment to the second point of attachment.

19. The method according to claim 18, further comprising continuously rerouting the incoming packets, while the predefined handoff label switched path is directed to a new point of attachment, until the request message reaches the gateway serving node where it is placed on a different label switched path that is directed to a new point of attachment.

20. The method according to claim 18, wherein the label switched paths are predefined for interfaces from the gateway support node to the serving support node, the method further comprising reflecting any interface change by an appropriate label switched path.

21. The method according to claim 18, further comprising receiving incoming packets at an ingress router, to optionally route the incoming packet through a switching router, and receiving the incoming packet at an egress router for further distribution to a component that is attached to the egress router.

22. The method according to claim 21, further comprising using at least one table for determining a routing path for the incoming packet at each of the ingress router, switching router and egress router.

23. The method according to claim 21, further comprising amending the incoming packet with information that is retrieved from the at least one table.

24. The method according to claim 21, wherein upon receiving the incoming packet, the method further comprising examining an associated handoff table and, if predefined information is not retrieved from the handoff table, examining an associated incoming label map for further routing information.

25. The method according to claim 21, wherein upon receiving the incoming packet, the method further comprising examining, by the egress router, an associated incoming label map and upon retrieving a null label, amending the incoming packet prior to forwarding the incoming packet to an appropriate point of attachment.

26. The method according to claim 18, wherein the request message is an Internet Protocol diagram, the method comprising including an Internet Protocol source address and a broadcast Internet Protocol destination address in the request message, the request message further comprises a user identifier, a network identifier for the first point of attachment and a network identifier for the second point of attachment.

27. The method according to claim 18, wherein the upon receipt of the request message, the method comprising examining, by the serving support node, an associated table for forwarding information for the second point of attachment and, if predefined information is not retrieved from the associated table, updating the associated table with the forwarding information for the second point of attachment and initializing a pending message counter.

28. The method according to claim 18, wherein upon receiving the request message, the method comprising examining, by the serving support node, an upstream map for each associated gateway support node and for each label switched path from the associated gateway support node, retrieving at least one interface, forwarding the request message on the retrieved interface, and updating a pending counter.

29. The method according to claim 18, wherein upon receiving the request message, the method comprising changing, by the gateway support node, an entry in a classification table to reflect the handoff request, wherein upon updating the classification table, incoming packets to the mobile station are routed on a new label switched path.

30. The method according to claim 18, wherein upon sending the request message to the gateway support node, the method comprising sending, by the serving support node, a responds message to the mobile station.

31. The method according to claim 18, further comprising authenticating by the mobile station, with the serving support node which forwards an authentication context to all neighboring serving support nodes that the mobile station might handoff to.

32. The method according to claim 18, further comprising authenticating, by at least one of the mobile station or network device, the handoff request message by generating an authentication token comprising a sequence number, an authentication management field and an authentication code and transmitting the authentication token and a random number to the network device for the network device to authenticate the mobile station.

33. An apparatus for enabling handoff of a mobile device from a first point of attachment to a second point of attachment, the apparatus comprising:
implementing means for implementing a protocol wherein incoming packets are forwarded based on predefined label switched paths,
issuing means for issuing, by a mobile station, a handoff request message to an attached serving support node which relays the message to an associated gateway support node when the mobile station moves from a first point of attachment to a second point of attachment;
acting means for acting, by each intermediate node receiving the request message, so that incoming packets destined for the mobile station are rerouted on a predefined handoff label switched path; and
forwarding means for forwarding the incoming packets from the serving support node to the second point of attachment during handoff from the first point of attachment to the second point of attachment.

34. A mobile device using a protocol wherein incoming packets are forwarded based on predefined label switched paths when the mobile device roams from a first point of attachment to a second point of attachment, the mobile device comprising:
a unit for issuing a handoff request message to an attached serving support node which relays the message to an associated gateway support node when the mobile station moves from a first point of attachment to a second point of attachment;
wherein each intermediate node receiving the request message takes action so that incoming packets destined for the mobile station are rerouted on a predefined handoff label switched path and wherein during handoff from the first point of attachment to the second point of attachment incoming packets are forwarded from the serving support node to the second point of attachment.

35. The mobile device according to claim 34, wherein the mobile device is configured to transmit incoming packets at an ingress router, the ingress routing being configured to optionally route the incoming packet through a switching router and to transmit the incoming packet at an egress router for further distribution to a component that is attached to the egress router.

36. The mobile device according to claim 34, wherein the mobile station is configured to authenticate with the serving support node which forwards an authentication context to all neighboring serving support nodes that the mobile station might handoff to.

37. The mobile device according to claim 34, wherein the mobile station is configured to authenticate the handoff request message by generating an authentication token comprising a sequence number, an authentication management field and an authentication code, the mobile station is further configured to transmit the authentication token and a random number to the network device for the network device to authenticate the mobile station.

38. A serving support node for enabling handoff of a mobile device from a first point of attachment to a second point of attachment, the serving support node comprising:
a unit for receiving handoff request message when a mobile station moves from a first point of attachment to a second point of attachment; and
a unit for relaying the request message to an associated gateway support node,
wherein each intermediate node receiving the request message takes action so that incoming packets destined for the mobile station are rerouted on a predefined handoff label switched path and wherein during handoff from the first point of attachment to the second point of attachment incoming packets are forwarded from the serving support node to the second point of attachment, and
wherein handoff is implemented in a system implementing a protocol wherein incoming packets are forwarded based on predefined label switched paths.

39. The serving support node according to claim 38, wherein while the predefined handoff label switched path is directed to a new point of attachment, the incoming packets are continuously rerouted, until the request message reaches the gateway serving node wherein the gateway serving node is configured to place the incoming packet on a different label switched path that is directed to a new point of attachment.

40. The serving support node according to claim 38, wherein the label switched paths are predefined for interfaces from the gateway support node to the serving support node such that any interface change is reflected by an appropriate label switched path.

41. The serving support node according to claim 38, wherein the upon receipt of the request message, the serving support node is configured to examine an associated table for forwarding information for the second point of attachment and, if predefined information is not retrieved from the associated table, to update the associated table with the forwarding information for the second point of attachment and to initialize a pending message counter.

42. The serving support node according to claim 38, wherein upon receiving the request message, the serving support node is configured to examine an upstream map for each associated gateway support node and for each label switched path from the associated gateway support node, to retrieve at least one interface and to forward the request message on the retrieved interface, the serving support node is further configured to update a pending counter.

43. The serving support node according to claim 38, wherein upon receiving the request message, the gateway support node is configured to change an entry in a classification table to reflect the handoff request, wherein upon updating the classification table, incoming packets to the mobile station are routed on a new label switched path.

44. The serving support node according to claim 38, wherein upon sending the request message to the gateway support node, the serving support node is configured to send a responds message to the mobile station.

45. An ingress router for enabling handoff of a mobile device from a first point of attachment to a second point of attachment, the ingress router comprising:
a unit for receiving incoming packets from a mobile device using a protocol, wherein incoming packets are forwarded based on predefined label switched paths when the mobile device roams from a first point of attachment to a second point of attachment,
a unit for optionally routing the incoming packet through a switching router; and
a unit for transmitting the incoming packet at an egress router for further distribution to a component that is attached to the egress router,
wherein the mobile device issues a handoff request message to an attached serving support node which relays the message to an associated gateway support node when the mobile station moves from the first point of attachment to the second point of attachment;
wherein each intermediate node receiving the request message takes action so that incoming packets destined for the mobile station are rerouted on a predefined handoff label switched path and wherein during handoff from the first point of attachment to the second point of attachment incoming packets are forwarded from the serving support node to the second point of attachment.

46. The ingress router according to claim 45, wherein each of the ingress router, switching router and egress router is configured to use at least one table for determining a routing path for the incoming packet.

47. The ingress router according to claim 46, each of the ingress router, switching router and egress router is configured to amend the incoming packet with information that is retrieved from the at least one table.

48. The ingress router according to claim 45, wherein upon receiving the incoming packet, the switching router is configured to examine an associated handoff table and, if predefined information is not retrieved from the handoff table, to examine an associated incoming label map for further routing information.

49. The ingress router according to claim 45, wherein upon receiving the incoming packet, the egress router is configured to examine an associated incoming label map and upon retrieving a null label, amend the incoming packet prior to forwarding the incoming packet to an appropriate point of attachment.
